(19) United States
(12) Patent Application Publication
(10) Pub. No.: US 2026/0237886 A1
(43) Pub. Date: Aug. 13, 2026

(54) ANTENNA ARRANGEMENT FOR A RADAR SENSOR

(71) Applicant: HELLA GMBH & CO. KGAA, Lippstadt (DE)

(72) Inventors: Zeid Abou-Chahine, Lippstadt (DE); Markus Fleger, Unna (DE); Andreas John, Lippstadt (DE); Uwe Kühnau, Ahlen (DE); Sascha Reuner, Berlin (DE); Mohammad Sharifi, Bad Waldliesborn (DE); Konstantin Rettner, Würzburg (DE); Carsten Zang, Untermerzbach (DE)

(21) Appl. No.: 19/535,183

(22) Filed: Feb. 10, 2026

(30) Foreign Application Priority Data
Feb. 11, 2025 (DE) 102025104913.0
May 8, 2025 (DE) 102025117706.6

(51) Int. Cl. H01Q 1/24; H01Q 1/32; H01Q 1/36; H01Q 1/38; H01Q 1/50; H01Q 21/28

(52) U.S. Cl. CPC H01Q 1/243; H01Q 1/3233; H01Q 1/36; H01Q 1/38; H01Q 1/50; H01Q 21/28

(57) ABSTRACT

The invention relates to an antenna arrangement for a radar sensor, having: an antenna body and a printed circuit board, which form a waveguide antenna. The antenna body has a first surface facing the printed circuit board and a second surface facing away from the printed circuit board. The first surface is formed with a first structure that provides wave interfaces to the printed circuit board and forms a waveguide structure. The antenna body is designed with transmitting and/or receiving structures, and the second surface is formed with a second structure that reduces undesirable surface effects.

### CROSS-REFERENCE TO RELATED APPLICATIONS

This application claims the benefit of German Patent Application 10-2025-104-913.0, filed Feb. 11, 2025, and German Patent Application 10-2025-117-706.6, filed May 8, 2025, the disclosures of which are incorporated by reference in their entirety.

### FIELD OF THE INVENTION

The invention relates to an antenna arrangement for a radar sensor.

### BACKGROUND OF THE INVENTION

Antenna arrangements for radar sensors are generally known. Known antenna arrangements have, for example, antenna bodies that have specific waveguide structures. The potential for developing antenna arrangements with improved wave propagation properties and antenna properties has not been exhausted.

### SUMMARY OF THE INVENTION

The object of the invention is to provide an improved antenna arrangement for a radar sensor which has desired wave propagation properties and improved antenna properties.

The object is achieved by the antenna arrangement with the features of the current embodiments. Features and details described in connection with the various embodiments of the invention naturally also apply in connection with the other embodiments, and vice versa, so that reference is or can always be made reciprocally with respect to the disclosure of the individual embodiments.

The present invention provides, according to the first aspect, an antenna arrangement for a radar sensor. The antenna arrangement has a (preferably one-piece) antenna body and a printed circuit board, which together form a waveguide antenna (or an air-filled waveguide). On the one hand, the antenna body has a first surface that faces the printed circuit board. On the other hand, the antenna body has a second surface that faces away from the printed circuit board.

Advantageously, the first surface is formed with a first structure such that wave interfaces to the printed circuit board are provided, and such that a waveguide structure is formed.

Furthermore, the antenna body is designed with transmitting and/or receiving structures (which can be referred to as Tx and/or Rx), for example in the form of pass-through openings. These structures can be used to guide radar waves from the inside to the outside and/or from the outside to the inside with regard to the waveguide antenna.

Advantageously, the second surface is designed with a second structure such that undesirable surface effects, in particular parasitic reflection effects from vehicle parts, are reduced.

The antenna arrangement according to the invention thus enables the following functionally essential structures: 1) wave interfaces to a feed element of the printed circuit board; 2) waveguide structure or waveguide profiles (for guiding the radar waves); 3) transmitting and/or receiving structures; and 4) structures for reducing undesirable surface effects.

The antenna arrangement according to the invention has improved efficiency and a simple and cost-effective design.

The first structure may have a plurality of pins arranged on the first surface to form waveguide channels between the wave interfaces and the transmitting and/or receiving structures. The diameter, height, and distance between the pins can be selected such that, with air gap tolerances, e.g., in the range of 0.15 mm+/−0.1 mm, a desired wave mode can exhibit acceptable propagation properties within the waveguide channels and low leakage between the waveguide channels.

Advantageously, the pins can have a specific height, diameter, shape, and/or distance between each other, which are determined such that an air gap between the pins and the printed circuit board, e.g., in the range of 0.15 mm+/−0.1 mm, can be permitted. Despite the air gap, desired wave propagation properties can be ensured within the wave guide channels and leakage between the wave guide channels can be avoided or, preferably, minimized. This eliminates the need for soldering or connecting the pins to the printed circuit board.

Furthermore, the height, diameter, shape, and distance of the pins can be coordinated such that local minima for the coupling between the waveguide channels result. This eliminates the need to solder the pins to the printed circuit board.

Furthermore, the first structure may have specifically placed impedance matching pins arranged on the first surface in the area of the wave interfaces to the printed circuit board. This enables impedance matching of an input wave to the waveguide channels.

Advantageously, the impedance matching pins can have a specific height, a specific shape, and/or a specific position on the first surface, which are determined such that, in the area of the wave interfaces to the printed circuit board, impedance matching, in particular impedance equalization, between feed openings of the printed circuit board and the antenna body is enabled. For example, the adjustment height may be smaller than the specified height of the pins. This allows for improved impedance matching, preferably over an entire air gap tolerance range between an electrically conductive layer on the printed circuit board and the first surface of the antenna body facing the printed circuit board. The impedance matching pins can act as impedance transformers and enable the necessary broadband impedance matching.

In addition, the first structure may have waveguide bridges arranged on the first surface to support waveguide guidance along the waveguide channels between the wave interfaces and the transmitting and/or receiving structures. In this way, the first structure can form a so-called “ridged gap wave guide” (or RGW for short).

Advantageously, the waveguide channels, with or without waveguide bridges, can be delimited by one row, two rows, or even several rows of pins. Preferably, the pins can be arranged outside the waveguide channels anywhere on the first surface where there is sufficient space between the antenna body and the printed circuit board. A waveguide bridge can be arranged between the pins to enable a further reduction in losses and to facilitate an isolation of channels, especially when only one row of pins is used between parallel waveguide channels.

The geometric parameters of the pins and/or waveguide bridges can advantageously be selected such that local minima for the coupling between the waveguide channels are created. In addition, the sensitivity to discontinuities in routing can be minimized in terms of transmission and reflection behavior (amplitudes and phases) relative to an air gap size by specifically selecting the pins and/or waveguide bridges.

Furthermore, in the area of feed openings on the printed circuit board, the waveguide bridges can have sloping ramps in order to enable impedance matching, in particular impedance equalization. Furthermore, in the area of the transmitting and/or receiving structures, the waveguide bridges have sloping ramps in order to enable impedance matching, in particular impedance equalization.

Preferably, the positions of the waveguide bridges and the dimensions of the transmitting and/or receiving structures (e.g., in the form of pass-through openings or slots) can be specifically selected to enable a desired efficiency and/or desired antenna properties. The dimensions of the slots and the position of the waveguide bridges can be selected to achieve good and robust input matching, good efficiency, and the shape of the antenna pattern, including air gap tolerances.

Advantageously, openings within the transmitting and/or receiving structures, as seen in cross-section through the antenna body, have a funnel shape that widens outwardly. This allows simple pass-through openings to be provided during manufacture.

Furthermore, the second structure has a plurality of, e.g., cylindrical, semicircular, rectangular, and/or cuboid stems arranged on the second surface in the area between the transmitting and/or receiving structures in order to reduce undesirable surface effects, in particular parasitic reflection effects. This reduces undesirable parasitic radiation from the second surface. At the same time, this can reduce undesirable rearward radiation toward vehicle components. The deterioration of the far-field amplitudes (ripple) and far-field phases (“cleaner radiation pattern”) can be reduced as a result. This enables better radiation properties for antenna operation, in particular also behind a painted bumper cover.

Furthermore, the second structure may have zigzag structures arranged on the second surface in the area between the transmitting and/or receiving structures in order to reduce undesirable surface effects, see FIG. 15. Zigzag structures can be used to reduce the effective backscatter cross section of the second surface for radar waves.

In principle, the antenna body can be formed from a plastic, in particular from a glass fiber reinforced plastic, for example as part of an injection molding process. In addition, the antenna body may have a metallic coating, in particular only on the first surface facing the printed circuit board.

Furthermore, the second structure may have an absorbing material which may be arranged on the second surface in the area between the transmitting and/or receiving structures in order to reduce undesirable surface effects. In principle, the antenna body can be formed from absorbing material, e.g., by injection molding, wherein after forming, a metallization (or coating with a metallic material) of the antenna body takes place, which is then partially removed to give the second structure absorbing properties. This reduces undesirable parasitic radiation from the second surface. In addition, partial metallization (preferably only on the first surface, not on the second surface) could be used on the antenna body to further influence undesirable waves. For example, the upper metallization of the antenna body can be omitted or the upper metallization can be completely or partially removed.

### BRIEF DESCRIPTION OF THE DRAWINGS

An exemplary embodiment of the invention is explained in more detail below with reference to the accompanying drawings. In the drawings:

FIG. 1 is a perspective view of an antenna arrangement;

FIG. 2 is an exemplary cross-sectional view through the antenna arrangement;

FIG. 3 is a top view of a first surface;

FIG. 4a is a top view of a first surface in the area of wave interfaces;

FIG. 4b is a perspective view of a first surface with impedance matching pins;

FIGS. 5a and 5b show an example of impedance matching with and without impedance matching pins;

FIGS. 5c and 4d show an example of reflection and transmission behavior with and without impedance matching pins;

FIGS. 6a and 6b show an example of reflection and transmission behavior with and without impedance matching pins;

FIG. 7 is an exemplary section of a first surface in the area of a waveguide channel;

FIG. 8 is an exemplary section of a first surface in the area of two parallel waveguide channels;

FIG. 9 is an exemplary cross-sectional view of the antenna arrangement transverse to a waveguide channel;

FIG. 10 shows the coupling behavior between two adjacent waveguide channels separated by a row of pins as a function of the size of the air gap;

FIG. 11 shows an exemplary transmitting and/or receiving structure on a first surface facing the printed circuit board;

FIG. 12 shows an exemplary transmitting and/or receiving structure on a second surface facing the outside space;

FIG. 13 is an exemplary cross-sectional view through a transmitting and/or receiving structure with funnel-shaped passages/openings;

FIG. 14 shows an exemplary second structure on a second surface facing outward; and

FIG. 15 shows an exemplary second structure on a second surface facing outward.

### DETAILED DESCRIPTION OF THE CURRENT EMBODIMENTS

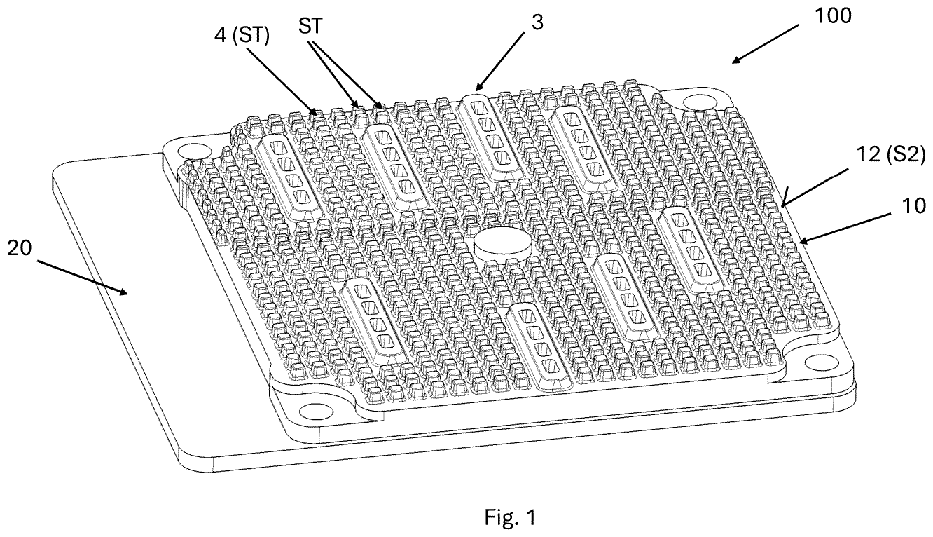

As illustrated in FIGS. 1 to 4, the present invention provides an antenna arrangement 100 for a radar sensor S. The antenna arrangement 100 has an antenna body 10 (preferably in one piece) and a printed circuit board 20, which together form a waveguide antenna (in particular an air-filled waveguide).

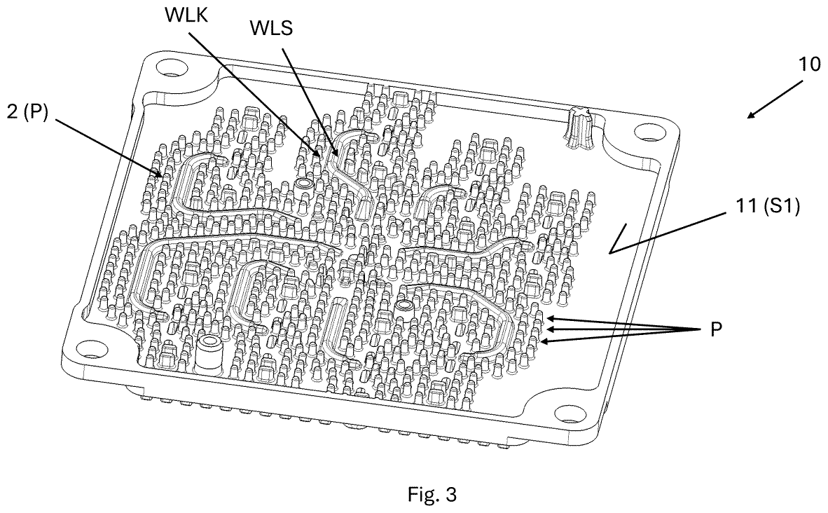

On the one hand, the antenna body 10 has a first surface 11 facing the printed circuit board 20 (see FIG. 3).

On the other hand, the antenna body 10 has a second surface 12 facing away from the printed circuit board 20 (see FIG. 1).

As FIG. 3 illustrates, the first surface 11 is formed with a first structure S1 such as: to provide wave interfaces 1 to the printed circuit board 20; and to form a waveguide structure 2.

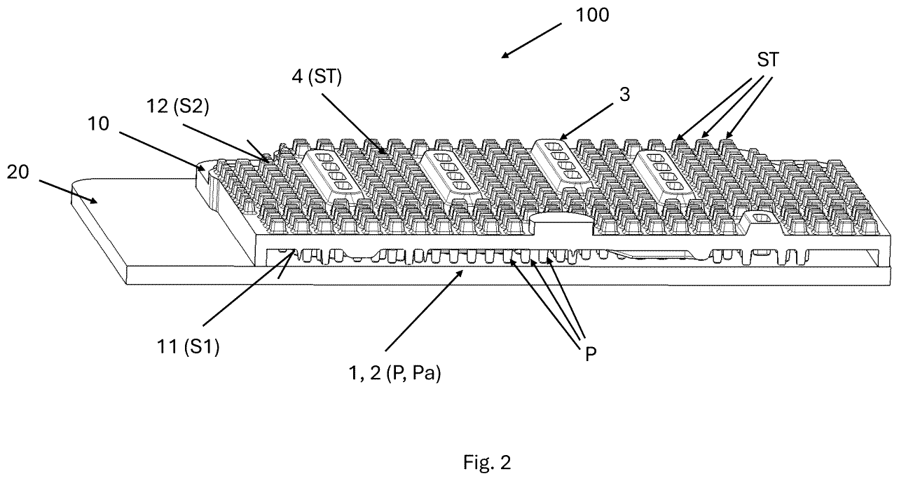

As indicated in FIG. 2, the antenna body 10 is designed with transmitting and/or receiving structures 3 (which can also be labeled Tx and/or Rx).

The transmitting and/or receiving structures 3 form pass-through openings to guide radar waves from the inside to the outside and/or from the outside to the inside with respect to the waveguide antenna.

As FIG. 1 illustrates, the second surface 12 is designed with a second structure S2 such as: to reduce undesirable surface effects 4, in particular parasitic reflection effects from vehicle parts.

The antenna arrangement 100 according to the invention therefore has the following functionally essential structures: (1) wave interfaces 1 to a feed element of the printed circuit board 20; (2) waveguide structure 2 or waveguide profiles (for guiding the radar waves); (3) transmitting and/or receiving structures 3; and (4) structures for reducing undesirable surface effects 4.

In this way, improved efficiency, improved performance, and a simple and cost-effective design of the antenna arrangement 100 can be achieved.

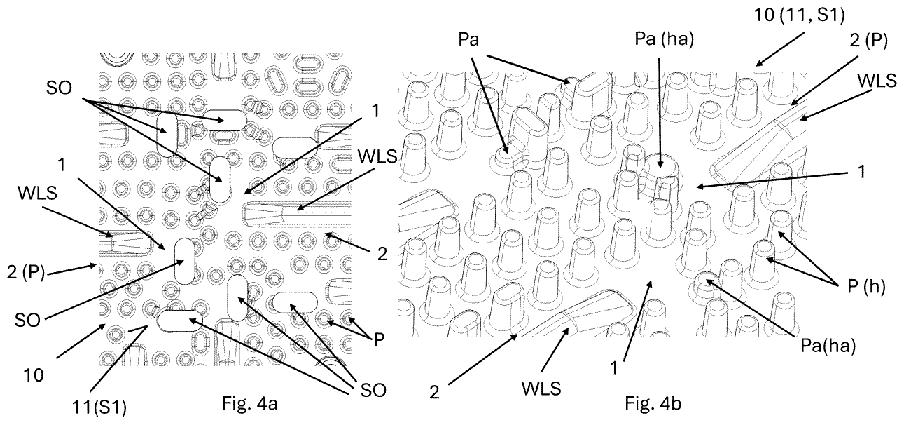

As indicated by FIGS. 3 and 4a as well as 4b, the first structure S1 may have a plurality of pins P arranged on the first surface 11 to form waveguide channels WLK between the wave interfaces 1 and the transmitting and/or receiving structures 3.

Advantageously, the pins P can have a specific height H, diameter, shape, and/or distance between each other, which are determined such that an air gap s between the pins P and the printed circuit board 20, e.g., in the range of 0.15 mm+/−0.1 mm, can be permitted. Despite the air gap, desired wave propagation properties can be ensured within the waveguide channels WLK and leakage between the waveguide channels WLK can be avoided or, preferably, minimized. This eliminates the need for soldering or connecting the pins P to the printed circuit board 20.

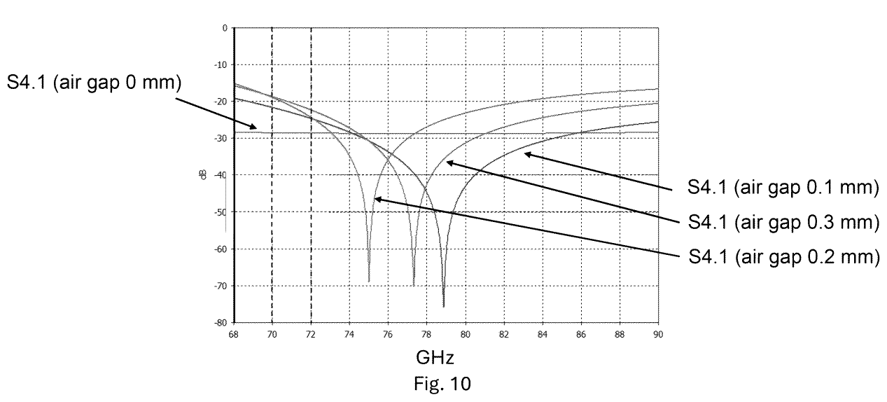

Furthermore, the shape and distances of the pins P can be coordinated such that local minima for coupling between the waveguide channels WLK result, see FIG. 10. FIG. 10 illustrates that the local minima for the coupling remain frequency-stable even with gap variations. The pins act as inductors and the air gaps between the pins P and the printed circuit board 20 act as capacitors. At a certain frequency, the inductors and capacitors can act as an oscillating circuit.

As FIG. 4b indicates, the first structure S1 has specifically placed impedance matching pins Pa which are arranged on the first surface 11 in the area of the wave interfaces 1 to the printed circuit board 20. FIG. 4b shows the designed wave interfaces 1 between feed openings SO of the printed circuit board 20 and the antenna body 10. This enables broadband impedance matching between feed openings and waveguide channels WLK.

Advantageously, the impedance matching pins Pa have a specific height ha, a specific shape, and/or a specific position on the first surface 11, which are determined such that, in the area of the wave interfaces 1 to the printed circuit board 20, impedance matching, in particular impedance equalization, between feed openings SO of the printed circuit board 20 and the antenna body 10 is enabled. For example, the adjustment height ha may be smaller than the specified height h of the pins P. In this way, improved impedance matching can be achieved, preferably over an entire air gap tolerance range between a copper layer of the printed circuit board 20 and the first surface 11 of the antenna body 10 facing the printed circuit board 20. The impedance matching pins Pa can act as impedance transformers and enable the necessary broadband impedance matching.

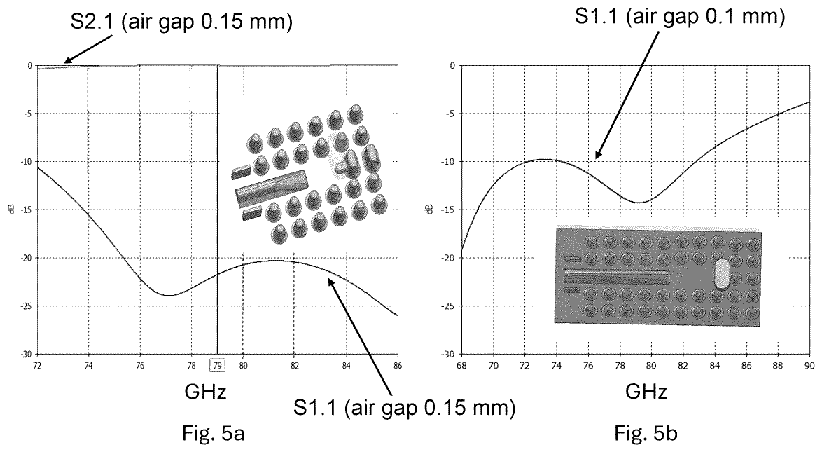

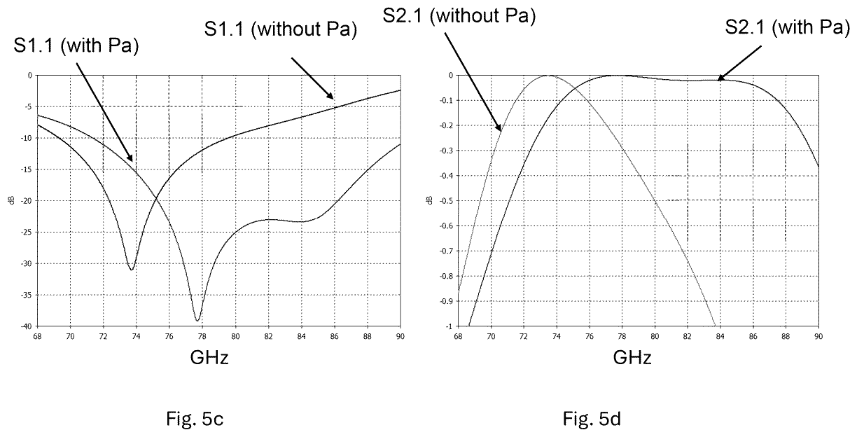

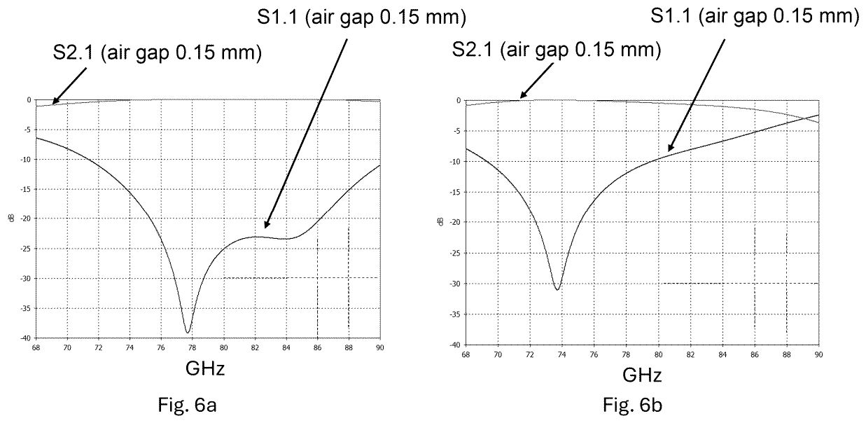

FIGS. 5 and 6 illustrate this positive effect. The adjustment improves by at least 5 dB in the desired frequency range of 76-81 GHz.

FIG. 5a shows impedance matching achieved with impedance matching pins Pa, and FIG. 5b shows impedance matching achieved without impedance matching pins Pa.

FIG. 5c shows the reflection behavior at the input of a waveguide channel WLK without impedance matching pins Pa (with a peak at approx. −30 dB) and with impedance matching pins Pa (with a peak at approx. −40 dB). It is evident that the reflection behavior is significantly improved with impedance matching pins Pa. FIG. 5d shows the transmission behavior from port to port of a waveguide channel WLK without impedance matching pins Pa (with a narrow bell curve at approx. 74 GHz) and with impedance matching pins Pa (with a significantly broader bell curve between 76 and 86 GHz). It is evident that the transmission behavior is significantly improved with impedance matching pins Pa.

FIG. 6a shows reflection and transmission behavior with matching pins Pa (left) and FIG. 6b without impedance matching pins Pa (right).

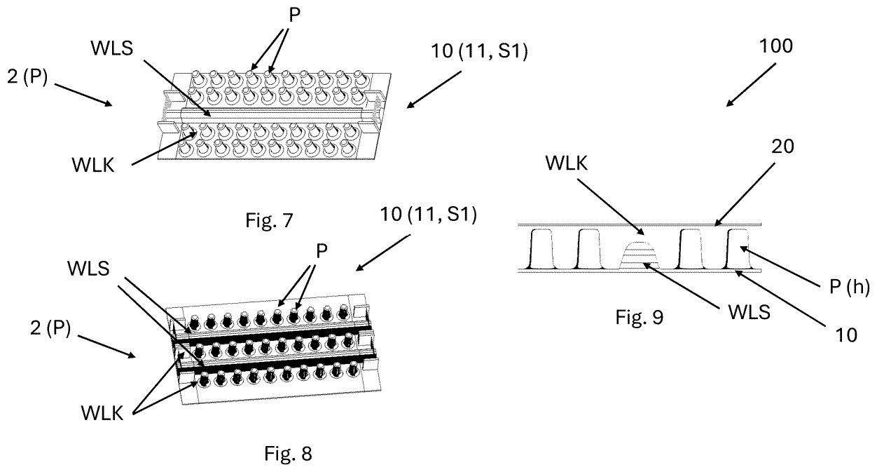

As illustrated in FIGS. 7, 8, and 9, the first structure S1 has waveguide bridges WLS arranged on the first surface 11 to support waveguide guidance along the waveguide channels WLK between the wave interfaces 1 and the transmitting and/or receiving structures 3. In this way, the first structure S1 can form a so-called ridged gap waveguide (or RGW for short), as shown by way of example in FIGS. 3, 4, 7, and 8.

Advantageously, the waveguide channels WLK, with or without the waveguide bridges WLS, can be delimited by at least one row (see FIG. 8), two rows (see FIG. 7), or even several rows (see FIG. 3) of pins P. Preferably, the pins P can be arranged outside the waveguide channels WLK anywhere on the first surface 11 (see FIG. 3) where there is sufficient space between the antenna body 10 and the printed circuit board 20. A waveguide bridge WLS can be arranged between the pins P to enable a further reduction in losses and to facilitate an isolation of channels, especially when only one row of pins P is used.

The geometric parameters of the pins P and/or the waveguide bridges WLS can advantageously be selected such that local minima for coupling between the waveguide channels WLK are created. In addition, the sensitivity to discontinuities in routing can be minimized in terms of transmission and reflection behavior (amplitudes and phases) relative to an air gap size by specifically selecting the pins P and/or waveguide bridges WLS.

Furthermore, in the area of feed openings SO of the printed circuit board 20, the waveguide bridges WLS can have sloping ramps or steps to enable impedance matching, in particular impedance equalization, see FIG. 4.

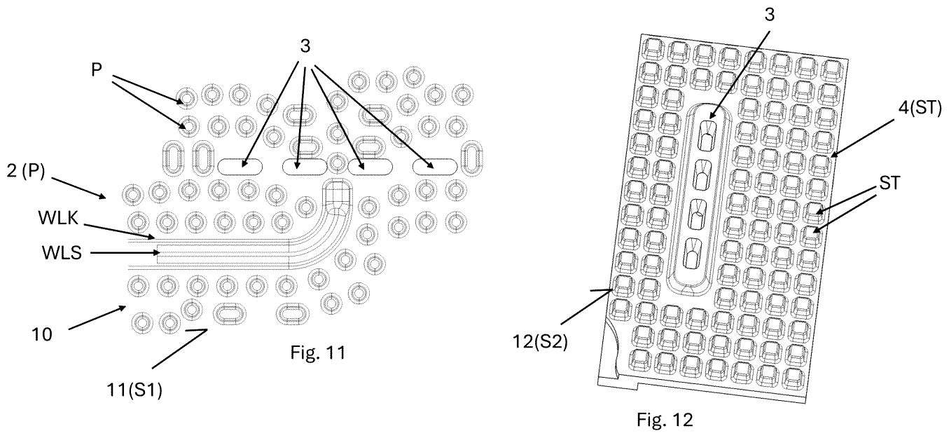

Furthermore, in the area of the transmitting and/or receiving structures 3, the waveguide bridges WLS can have sloping ramps to enable impedance matching, in particular impedance equalization, see FIG. 11.

Preferably, the positions of the waveguide bridges WLS and the dimensions of the transmitting and/or receiving structures 3 (e.g., in the form of pass-through openings or slots) can be specifically selected to enable a desired efficiency and/or desired antenna properties. The dimensions of the slots and the position of the waveguide bridges WLS can be selected so that good and robust input matching, good efficiency, and the desired shape of the antenna pattern, including air gap tolerances, can be achieved.

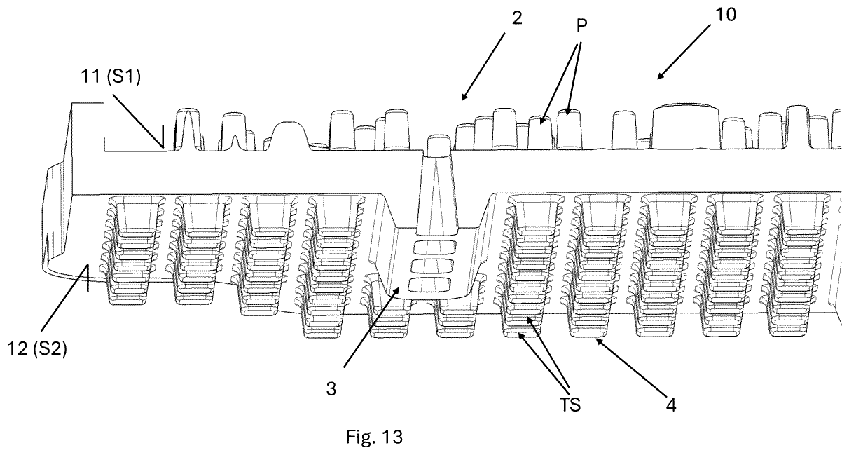

Advantageously, openings within the transmitting and/or receiving structures 3, as seen in cross-section through the antenna body 10, can have a funnel shape that widens outwardly, see FIG. 13.

While conventional transmitting and/or receiving structures 3 adapt a straight transmission line, in which the radiating elements would have to be offset relative to the transmission line, the proposed transmitting and/or receiving structures 3 function differently. The pins P on the first surface 11 of the antenna body 10 can form a curved transmission line in order to achieve amplitude allocation, see FIG. 11. In this way, a highly symmetrical pattern can be achieved, making the feed direction irrelevant; furthermore, “butterfly lobes” can be avoided, since the openings within the transmitting and/or receiving structures 3 do not need to be offset from each other.

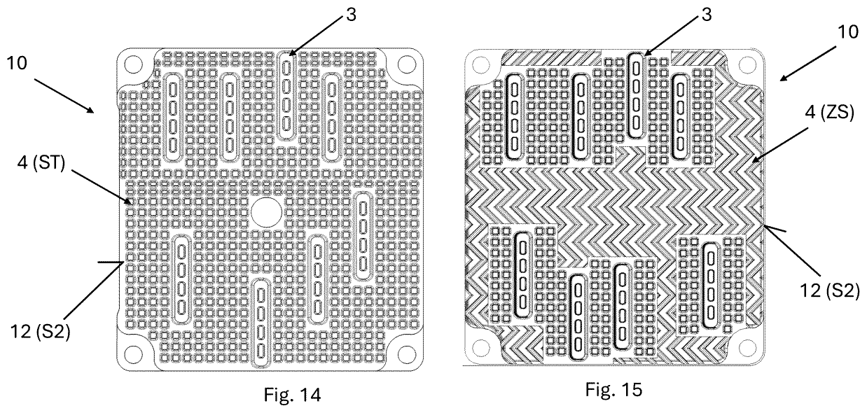

Furthermore, the second structure S2 can have a plurality of rectangular and/or cuboid stems ST (or other shapes, e.g., cylindrical, semicircular, or the like) arranged on the second surface 12 in the area between the transmitting and/or receiving structures 3 in order to reduce undesirable surface effects 4, in particular parasitic radiation effects and coupling, see FIG. 14. This reduces undesirable parasitic radiation from the second surface 12. At the same time, this can reduce undesirable rear radiation from vehicle components. The deterioration of the far-field amplitudes for ripple and far-field phases for a “cleaner radiation pattern” can be mitigated by this. This enables better radiation properties for antenna operation, e.g., behind a painted bumper cover.

Furthermore, the second structure S2 can have zigzag structures ZS, which are arranged on the second surface 12 in the area between the transmitting and/or receiving structures 3 in order to reduce undesirable surface effects 4, see FIG. 15. Zigzag structures ZS can be used to reduce the effective backscatter cross section of the second surface 12 for radar waves.

In principle, the antenna body 10 can be formed from a plastic, in particular from a glass fiber reinforced plastic, for example as part of an injection molding process. In addition, the antenna body 10 has a metallic coating, in particular only on the first surface 11 facing the printed circuit board 20.

Furthermore, the second structure S2 can have an absorbing material that can be arranged on the second surface 12 in the area between the transmitting and/or receiving structures 3 in order to reduce undesirable surface effects 4. This reduces undesirable parasitic radiation from the second surface 12. In addition, partial metallization could preferably be used only on the first surface 11, but not on the second surface 12, on the antenna body 10 in order to further influence undesirable waves. For example, the upper metallization of the antenna body 10 can be omitted or the upper metallization can be removed.

The preceding description of the figures describes the present invention exclusively in the context of examples. Of course, individual features of the embodiments can be freely combined with each other, provided this is technically expedient, without departing from the scope of the invention.

### LIST OF REFERENCE SYMBOLS

100 antenna arrangement
10 antenna body
11 first surface
S1 first structure
12 second surface
S2 second structure
1 wave interfaces
2 waveguide structure
3 transmitting and/or receiving structures
4 undesirable surface effects
P pins
h height
Pa impedance matching pins
ha adjustment height
WLK waveguide channels
WLS waveguide bridges
ST stems
ZS zigzag structures
20 printed circuit board
SO feed openings

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An antenna arrangement for a radar sensor, having:
an antenna body and a printed circuit board, which together form a waveguide antenna;
wherein the antenna body has a first surface facing the printed circuit board;
wherein the antenna body has a second surface facing away from the printed circuit board;
wherein the first surface is formed with a first structure that provides wave interfaces to the printed circuit board and forms a waveguide structure;
wherein the antenna body comprises a plurality of transmitting and/or receiving structures; and
wherein the second surface is formed with a second structure that reduces undesirable surface effects.

2. The antenna arrangement according to claim 1, wherein the first structure comprises a plurality of pins arranged on the first surface to form waveguide channels between the wave interfaces and the plurality of transmitting and/or receiving structures.

3. The antenna arrangement according to claim 2, wherein the plurality of pins have at least one of a specific height, a specific diameter, a specific shape, and a specific distance between each other, which are determined such that air gaps between the plurality of pins and the printed circuit board are present, desired wave propagation properties within the waveguide channels are ensured, and leakage between the waveguide channels can be avoided or minimized.

4. The antenna arrangement according to claim 3, wherein the air gaps are in the range of 0.15 mm+/−0.1 mm.

5. The antenna arrangement according to claim 2, wherein at least one of a height of the plurality of pins, a diameter of the plurality of pins, a shape of the plurality of pins, and a distance between the pins of the plurality of pins are coordinated such that local minima for coupling between the waveguide channels are created.

6. The antenna arrangement according to claim 2, wherein the plurality of pins are arranged outside the waveguide channels anywhere on the first surface where there is sufficient space between the antenna body and the printed circuit board.

7. The antenna arrangement according to claim 2, wherein the first structure has waveguide bridges arranged on the first surface to support waveguide guidance along the waveguide channels between the wave interfaces and the plurality of transmitting and/or receiving structures.

8. The antenna arrangement according to claim 2, wherein at least some of the plurality of pins are arranged in at least one row, and the waveguide channels are delimited by the at least one row of pins.

9. The antenna arrangement according to claim 8, wherein geometric parameters of the plurality of pins and the waveguide bridges are determined such that local minima for coupling between the waveguide channels are created.

10. The antenna arrangement according to claim 8, wherein the waveguide bridges comprise at least one of:
sloping ramps in the area of feed openings of the printed circuit board to enable at least one of impedance matching and impedance equalization; and
sloping ramps in the area of transmitting and/or receiving structures in order to enable at least one of impedance matching and impedance equalization.

11. The antenna arrangement according to claim 1, wherein the transmitting and/or receiving structures comprise openings having a funnel shape that widens outwardly.

12. The antenna arrangement according to claim 1, wherein the second structure has a plurality of stems arranged on the second surface in the area between the transmitting and/or receiving structures in order to reduce parasitic reflection effects.

13. The antenna arrangement according to claim 1, wherein the second structure has zigzag structures arranged on the second surface in the area between the transmitting and/or receiving structures in order to reduce undesirable surface effects.

14. The antenna arrangement according to claim 8, wherein positions of the waveguide bridges and dimensions of the transmitting and/or receiving structures are selected to enable at least one of a desired efficiency and desired antenna properties.

15. The antenna arrangement according to claim 1, wherein the first structure comprises a plurality of impedance matching pins which are arranged on the first surface in the area of the wave interfaces to the printed circuit board.

16. The antenna arrangement according to claim 15, wherein the impedance matching pins have at least one of a specific height, a specific shape, and a specific position on the first surface, which are determined such that, in the area of the wave interfaces to the printed circuit board, at least one of impedance matching and impedance equalization between feed openings of the printed circuit board and the antenna body is enabled.

17. The antenna arrangement according to claim 15, wherein the first structure has a plurality of pins arranged on the first surface to form waveguide channels and wherein the plurality of impedance matching pins have a height that is smaller than a height of the plurality of pins.

18. The antenna arrangement according to claim 1, wherein the second structure has an absorbent material arranged on the second surface in the area between the transmitting and/or receiving structures in order to reduce undesirable surface effects.

19. The antenna arrangement according to claim 1, wherein the antenna body is formed from an absorbing material and has a partial metallic coating that imparts absorbing properties to the second structure.

20. The antenna arrangement according to claim 1, wherein the antenna body is formed from a plastic and wherein the antenna body has a metallic coating only on the first surface facing the printed circuit board.
